(19) United States
(12) Patent Application Publication
(10) Pub. No.: US 2015/0238954 A1
(43) Pub. Date: Aug. 27, 2015

(54) FLUID ANALYSIS CARTRIDGE

(71) Applicant: SAMSUNG ELECTRONICS CO., LTD., Suwon-si (KR)

(72) Inventors: Takashi SHIMAYAMA, Seoul (KR); Soo-hong KIM, Yongin-si (KR); Sung-joon PARK, Suwon-si (KR)

(73) Assignee: SAMSUNG ELECTRONICS CO., LTD., Suwon-si (KR)

(21) Appl. No.: 14/632,002

(22) Filed: Feb. 26, 2015

Related U.S. Application Data
(60) Provisional application No. 61/977,868, filed on Apr. 10, 2014.

(30) Foreign Application Priority Data
Feb. 26, 2014 (KR) 10-2014-0022890

(51) Int. Cl. B01L 3/00

(52) U.S. Cl. CPC B01L 3/502; B01L 2300/14; B01L 2300/12

(57) ABSTRACT

A fluid analysis cartridge includes: an assistant plate including an inlet hole configured to receive a fluid; a main plate configured to receive the fluid via the assistant plate and further configured to store a reagent configured to react with the fluid; and a valve provided in the inlet hole and configured to control a flow of the fluid into the main plate according to pressure in the inlet hole.

### CROSS-REFERENCE TO RELATED APPLICATIONS

This application claims priority to Korean Patent Application No. 10-2014-0022890, filed on Feb. 26, 2014 in the Korean Intellectual Property Office, and U.S. Provisional Application No. 61/977,868, filed on Apr. 10, 2014 in the U.S. Patent and Trademark Office, the disclosures of which are incorporated herein in their entirety by reference.

### BACKGROUND

1. Field

One or more exemplary embodiments relate to a cartridge for analyzing a fluid.

2. Description of the Related Art

An apparatus and a method of analyzing a fluid are used in various fields such as environmental monitoring, food inspection, and medical diagnosis. Conventionally, various processes such as reagent injection, mixing, separation, controlling flow, reaction, and centrifugation have to be manually performed by one skilled in the art during inspection of a sample according to a predetermined protocol, and such processes may result in errors.

To overcome such problems, a miniaturized and automated apparatus has been developed for rapidly analyzing an inspection material. More particularly, a portable fluid analysis cartridge may rapidly analyze the inspection material without being limited with respect to a location and thus, when a structure and functions thereof are improved, the portable fluid analysis cartridge may perform a greater number of functions in various fields.

### SUMMARY

Exemplary embodiments provide a fluid analysis cartridge having improved convenience for a user and a structure enabling various analyses.

Additional aspects will be set forth in part in the description which follows and, in part, will be apparent from the description, or may be learned by practice of the presented exemplary embodiments.

According to an aspect of an exemplary embodiment, there is provided a fluid analysis cartridge including: an assistant plate including an inlet hole configured to receive a fluid; a main plate configured to receive the fluid via the assistant plate and further configured to store a reagent configured to react with the fluid; and a valve provided in the inlet hole and configured to control a flow of the fluid into the main plate according to pressure in the inlet hole.

The valve is configured to block the fluid from flowing into the main plate when the pressure is less than or equal to a first pressure.

The first pressure may be an atmospheric pressure.

When the pressure is greater than or equal to a second pressure, the fluid may pass through the valve and flows into the main plate.

The second pressure may be higher than an atmospheric pressure.

The valve may include a membrane configured to block the inlet hole.

The valve may include a hydrophobic material.

The valve may include a gas-permeable material.

The valve may include at least one of polytetrafluoroethylene (PTFE), polyethylene (PE), polypropylene (PP), polysulfone (PSF), polyacrylonitrile (PAN), and cellulose acetate (CA).

The main plate may include: a first plate, a second plate spaced apart from the first plate; and a third plate provided between the first and second plates and including a reaction chamber configured to store the reagent and a fluid path configured to guide the fluid through the main plate towards the reaction chamber.

The third plate may be formed of a gas-permeable material.

The first and second plates may be formed of at least one film selected from polyethylene films formed of a very low density polyethylene (VLDPE), linear low density polyethylene (LLDPE), low density polyethylene (LDPE), medium density polyethylene (MDPE), and high density polyethylene (HDPE); a polypropylene (PP) film; a poly (vinyl chloride) (PVC) film; a polyvinyl alcohol (PVA) film; a polystyrene (PS) film; and a polyethylene terephthalate (PET) film.

The assistant plate may be formed of at least one selected from among polymethylmethacrylate (PMMA), polydimethylsiloxane (PDMS), polycarbonate (PC), linear low density polyethylene (LLDPE), low density polyethylene (LDPE), medium density polyethylene (MDPE), high density polyethylene (HDPE), polyvinyl alcohol, very low density polyethylene (VLDPE), polypropylene (PP), acrylonitrile butadiene styrene (ABS), cycloolefin copolymer (COC), glass, mica, silica, and a semiconductor wafer.

The fluid analysis cartridge may further include a space configured to store the fluid, the space being formed by the valve and a surface of the assistant plate.

The valve may be provided between the assistant plate and the main plate.

The assistant plate may further include a filter provided in the inlet hole, wherein the filter is spaced apart from the valve and is configured to filter a specific material included in the fluid.

The filter may be provided on the valve.

The filter may include a membrane configured to block the inlet hole.

The assistant plate may include: a fourth plate contacting the valve; and a fifth plate disposed on the fourth plate and contacting the filter.

The assistant plate may be configured to guide the fluid in a first direction, and the main plate may be configured to guide the fluid in a second direction perpendicular to the first direction.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a fluid analysis cartridge according to an exemplary embodiment;

FIG. 2 is an exploded perspective view in which a main plate of a fluid analysis cartridge according to an exemplary embodiment is separated into layers;

FIG. 3 is a side cross-sectional view of a fluid analysis cartridge according to an exemplary embodiment;

FIGS. 4A to 4B show passage of fluid according to pressure in the fluid analysis cartridge of FIG. 3;

FIGS. 5 to 9 show side cross-sectional views of a fluid analysis cartridge according to another exemplary embodiment;

FIGS. 10A to 10F are plan views of a third plate in a main plate of the fluid analysis cartridge according to an exemplary embodiment;

FIGS. 11A and 11B show absorbances in a reaction chamber according to application of pressure to the fluid analysis cartridge of FIG. 1;

FIG. 12A is a graph showing a relationship between a concentration of ascorbic acid and alanine aminotransferase (ALT) when an oxidase is not present; and

FIG. 12B is a graph showing a relationship between a concentration of ascorbic acid and alanine aminotransferase (ALT) when an oxidase is present.

### DETAILED DESCRIPTION

Reference will now be made in detail to exemplary embodiments, examples of which are illustrated in the accompanying drawings, wherein like reference numerals refer to the like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

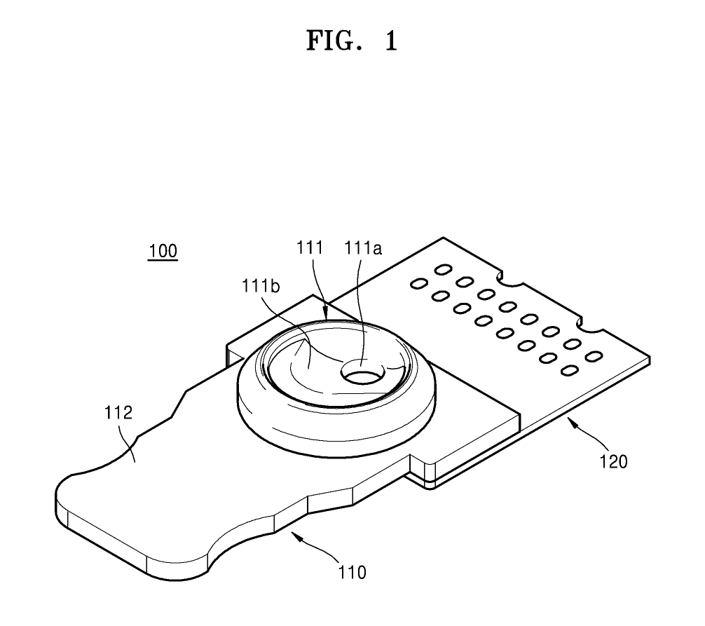

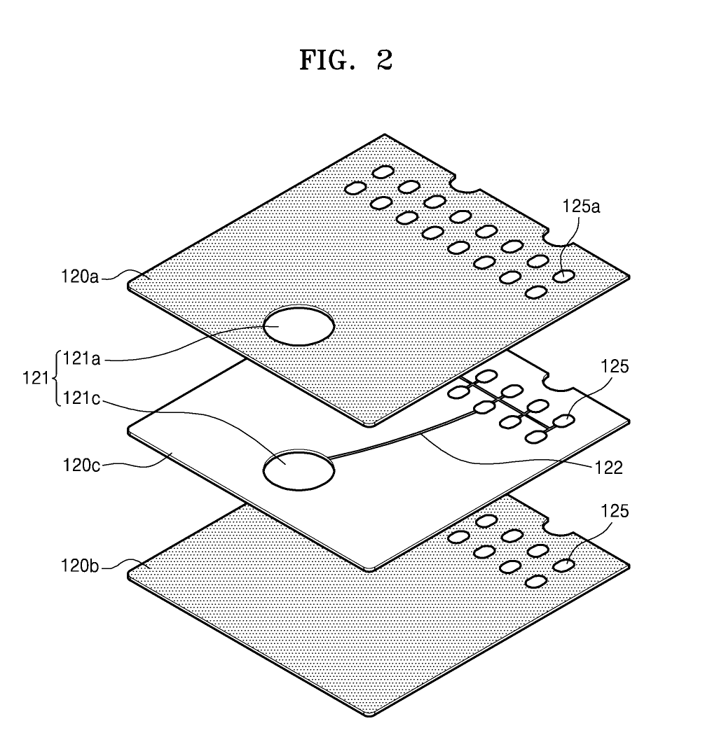

FIG. 1 illustrates a fluid analysis cartridge according to an exemplary embodiment and FIG. 2 is an exploded perspective view in which a main plate of a fluid analysis cartridge according to an exemplary embodiment is separated into layers. A fluid analysis cartridge 100 according to an exemplary embodiment may include an assistant plate 110 into which a fluid flows from outside and a main plate 120 in which the fluid that flows into the assistant plate 110 reacts with a reagent. The fluid that may be analyzed in the fluid analysis cartridge 100 according to an exemplary embodiment may be a biological sample such as blood, tissue fluid, lymph fluid, fluid including bone marrow, saliva, and urine or an environmental sample for water quality management or soil management, but the exemplary embodiments are not limited with respect to types of the fluid subject to the analysis.

The assistant plate 110 includes a fluid inlet portion 111 into which a fluid may flow from outside and a grip portion 112 via which a user may hold the fluid analysis cartridge 100. The fluid inlet portion 111 may include a fluid inlet hole 111a through which the fluid flows onto the main plate 120 and a fluid guide portion 111b guiding the flow of the fluid.

The fluid inlet hole 111a may be formed into a circular shape as shown in FIG. 1, but the shape thereof is not limited thereto and may be formed into a pentagonal shape or many other types of shapes. A user may use a tool such as a pipette or a spuit to drop a fluid subject to analysis into the fluid inlet hole 111a. However, as the fluid analysis cartridge 100 becomes smaller, the size of the fluid inlet hole 111a may be limited, such that when the size of the fluid inlet hole 111a is reduced, the fluid may not be easily dropped into the fluid inlet hole 111a in a precise manner.

Accordingly, the fluid guide portion 111b may be formed at a negative angle of inclination in a direction of the fluid inlet hole 111a, near the fluid inlet hole 111a, such that the fluid dropped around the fluid inlet hole 111a may flow into the fluid inlet hole 111a. In more detail, when the user does not precisely drop the fluid into the fluid inlet hole 111a, such that a portion of the fluid is dropped near the fluid inlet hole 111a, the fluid dropped near the fluid inlet hole 111a flows into the fluid inlet hole 111a due to the negative angle of inclination of the fluid guide portion 111b.

Also, the fluid guide portion 111b not only guides the flowing of the fluid, but also prevents erroneous flowing of the fluid, thereby preventing contamination of the fluid cartridge 100. In more detail, even when the fluid is not precisely dropped into the fluid inlet hole 111a, the fluid guide portion 111b near the fluid inlet hole 111a prevents the fluid from flowing onto the main plate 120 or the grip portion 112, which prevents the fluid from contaminating the fluid analysis cartridge 100, and further prevents contact between the user and a fluid that may be harmful for the user.

The fluid inlet portion 111 is exemplarily described as including one fluid inlet hole 111a, but the fluid analysis cartridge 100 according to an exemplary embodiment may include a plurality of fluid inlet holes 111a.

The fluid inlet hole 111a may have a diameter of about 0.5 mm to about 20 mm, but this is only an example of a size of the fluid inlet hole 111a, and the fluid inlet hole 111a may have various sizes depending on the size of the entire fluid analysis cartridge 100, the number of fluid inlet holes 111a, and the type of fluid being analyzed.

When a plurality of fluid inlet holes 111a are provided, different fluids may be simultaneously analyzed in one fluid analysis cartridge 100. In this regard, a plurality of different fluids may be of the same type but supplied from different sources, may be of different types and supplied from different sources, or may be of the same type and supplied from a common source but in different states.

For example, when there are two fluid inlet holes 111a, one fluid inlet hole 111a may receive blood of a patient and another fluid inlet hole may receive lymph fluid of the same patient. Alternatively, blood of a patient may flow through one fluid inlet hole 111a and blood of another patient may flow through another fluid inlet hole.

Alternatively, although not shown, when there are four fluid inlet holes 111a, four blood samples extracted at a predetermined interval from the same patient may flow through the same fluid inlet hole 111a, and blood samples extracted from different patients may respectively flow through the four fluid inlet holes 111a.

The grip portion 112 may be used to rapidly analyze the fluid without being limited with respect to a location where the analysis takes place. More particularly, with regard to an inspection of a biological sample extracted from a human body, an inspection performed outside a central inspection room by a user such as a patient, a doctor, a nurse, and a medical laboratory technician at a location such as a home, an office, an out-patient facility, a hospital room, an emergency room, an operating room, an intensive care unit, and the like, is referred to as point of care testing (POCT). The fluid analysis cartridge 100 used during the point of care testing is frequently carried to many locations by the user and thus, there is a risk of dropping the fluid analysis cartridge 100 while carrying the same. In addition, if the fluid analysis cartridge 100 is not properly held during the flowing of the fluid, the fluid may not easily flow into the fluid analysis cartridge 100.

Accordingly, the assistant plate 110 of the fluid analysis cartridge 100 according to an exemplary embodiment provides the grip portion 112 that enables the user to easily hold the fluid analysis cartridge 100. Referring to FIG. 1, the grip portion 112 is formed as a streamlined protrusion, such that the user may not touch the main plate 120 or the fluid inlet portion 111 and may stably hold the fluid analysis cartridge 100.

The assistant plate 110 as described above has a shape for achieving a specific function and may come in contact with the fluid, and thus, the assistant plate 110 may be easily molded or be formed of a chemically or biologically inactive material. For example, the assistant plate 110 may be formed of various materials, for example, a plastic such as an acryl such as polymethylmethacrylate (PMMA), a poly-siloxane such as polydimethylsiloxane (PDMS); polycarbonate (PC); a polyethylene such as a linear low density polyethylene (LLDPE), a low density polyethylene (LDPE), a medium density polyethylene (MDPE), and a high density polyethylene (HDPE), a polyvinyl alcohol, an ultra low density polyethylene (VLDPE), a polypropylene (PP), an acrylonitrile-styrene butadiene (ABS), and cycloolefin copolymer (COC); glass; mica; silica; and a semiconductor wafer. However, the materials are only examples of materials that may be used as materials for the assistant plate 110 and the exemplary embodiments are not limited thereto. Any material that has chemical and biological stability and mechanical workability may be used as a material for the assistant plate 110 according to an exemplary embodiment.

The main plate 120 may include a flow path 122 through which the fluid moves and at least one reaction chamber 125 in which the fluid and a reagent react. In more detail, the main plate 120, as illustrated in FIG. 2, may be formed to have a structure in which three plates are bound together. The three plates may include a first plate 120a, a second plate 120b, and a third plate 120c, in which the first plate 120a and the second plate 120b may be coated with light shielding ink. As such, the fluid moving to the reaction chamber 125 may be protected from external light, and errors may be prevented from occurring during a measurement of optical properties in the reaction chamber 125.

The first plate 120a, the second plate 120, and the third plate 120c may each have a thickness of about 10 μm to about 300 μm, and the first plate 120a and the second plate 120b may be formed as films. However, the thicknesses of the first plate 120a, the second plate 120b, and the third plate 120c are given as examples only and the thickness of the main plate 120 is not limited thereto.

The film used for forming the first plate 120a and the second plate 120b may be selected from polyethylene films formed of a very low density polyethylene (VLDPE), linear low density polyethylene (LLDPE), low density polyethylene (LDPE), medium density polyethylene (MDPE), and high density polyethylene (HDPE); a polypropylene (PP) film; a poly (vinyl chloride) (PVC) film; a polyvinyl alcohol (PVA) film; a polystyrene (PS) film; and a polyethylene terephthalate (PET) film. However, the film is only an example of types of films which may be applied to the main plate 120 according to an exemplary embodiment, and any film formed of a material that is chemically and biologically inactive and has mechanical workability may be used as a film for forming the first plate 120a and the second plate 120b of the main plate 120.

The flow path 122 and the reaction chamber 125 may be formed on the third plate 120c through an opening. The third plate 120c is formed of a porous sheet such as cellulose, unlike the first plate 120a and the second plate 120b. Accordingly, the third plate 120c acts as a vent and enables the fluid to flow in the main plate 120 without a separate driving source. A detailed description of the third plate 120c of the main plate 120 is given below.

A portion 125a corresponding to the reaction chamber 125 of at least one of the first plate 120a and the second plate 120b may be treated to make the portion 125a transparent. Optical properties of a reaction occurring in the reaction chamber 125 may be visually confirmed via the portion 125a.

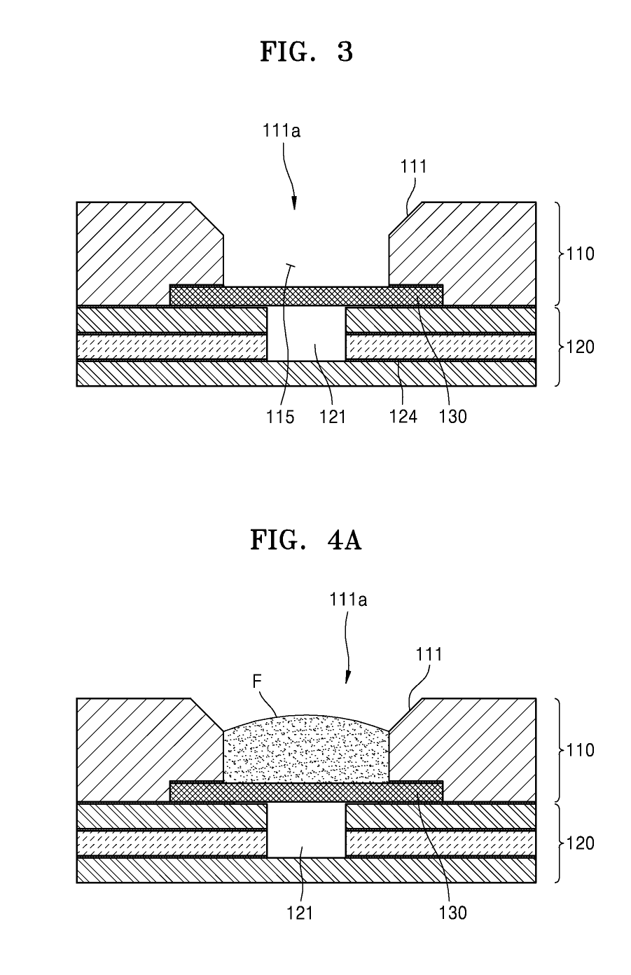

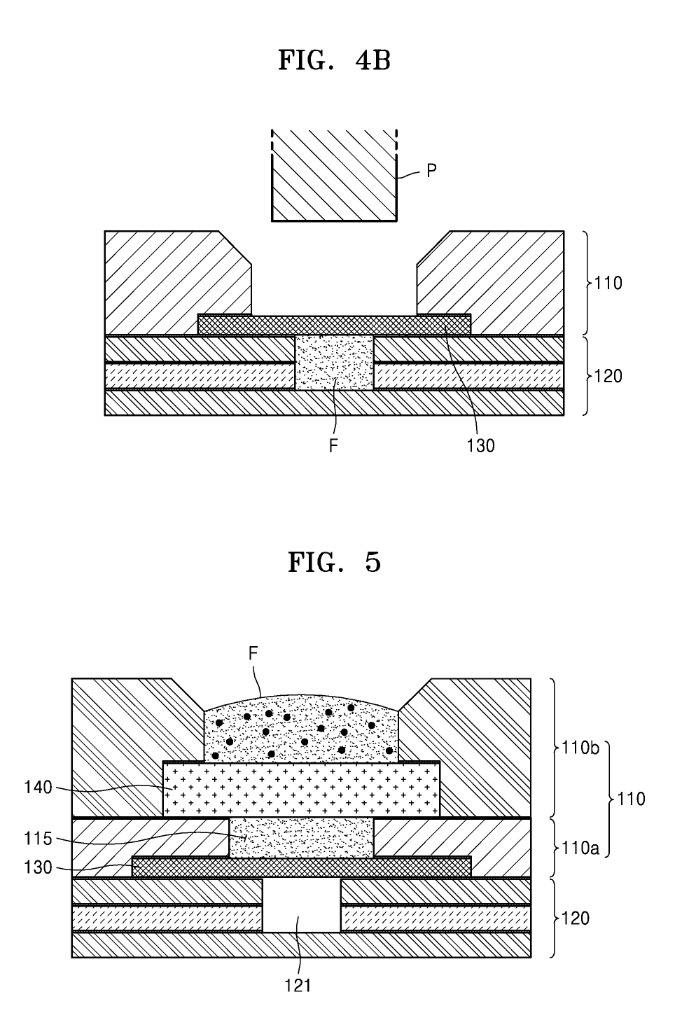

FIG. 3 is a side cross-sectional view of the fluid analysis cartridge 100 according to an exemplary embodiment and FIGS. 4A to 4B show passage of fluid through a valve according to pressure in the fluid analysis cartridge of FIG. 3. As illustrated in FIG. 3, an entrance 121 of the main plate 120 may be disposed on a bottom portion of a fluid flow inlet (not shown) of the assistant plate 110. Accordingly, the fluid which flows from the fluid inlet hole 111a in the fluid flow inlet may flow to a reaction chamber through a flow path of the main plate 120.

On the other hand, a valve 130 for controlling the flow of the fluid to the main plate 120 may be formed in the fluid inlet hole 111a of the assistant plate 110. The valve 130 described above may be a membrane for blocking the fluid inlet hole 111a. Generally, the fluid to be analyzed by the fluid analysis cartridge 100 according to an exemplary embodiment may be a liquid that has water as the main component thereof, such as blood. Accordingly, the valve 130 may include a hydrophobic material. Also, the valve 130 may include a gas permeable material through which gas may pass but liquid may not pass. For example, the valve 130 may include polytetrafluoroethylene (PTFE). Also, the valve 130 may be a membrane formed of a gas permeable material and coated with a hydrophobic material.

Also, the valve 130 may be disposed between the assistant plate 110 and the main plate 120. For example, together with the assistant plate 110, the valve 130 may form a space in which the fluid may stay (hereinafter, referred to as an “assistant reaction chamber 115”) in the fluid inlet hole 111a. Accordingly, even when the fluid flows through the flow inlet hole 111, the fluid remains in the assistant reaction chamber 115, such that the user may put a reagent for a pre-treatment of the fluid in the assistant reaction chamber 115. Also, a reaction for measuring optical or electrical changes may be performed in the assistant reaction chamber 115.

The valve 130 may control whether the fluid may move to the main plate 120, according to pressure in the fluid inlet hole 111a. For example, when the pressure in the fluid inlet hole 111a is less than or equal to a first pressure, as illustrated in FIG. 4A, the fluid F may not pass through the valve 130 and may stay in the assistant reaction chamber 115. However, when the pressure in the fluid inlet hole 111a is greater than a second pressure, as illustrated in FIG. 4B, the fluid F passes through the valve 130 to flow through the main plate 120. In this regard, the first pressure may be atmospheric pressure and the second pressure may be pressure greater than the atmospheric pressure. To apply pressure in the fluid inlet hole 111a equal to the second pressure, a pressure pump, for example, a plunger P, may be used.

The assistant plate 110, the main plate 120, and the valve 130 in the fluid analysis cartridge 100 may be immobilized by an adhesive material 124, such as a double sided adhesive. However, non-limiting components of the fluid analysis cartridge 100 may be bonded together. In the bonding between the assistant plate 110 and the main plate 120, a pressure sensitive adhesive (PSA) may be used, in which the PSA may bond to an adherend in a short period of time by using a small amount of pressure such as acupressure at room temperature. When using the PSA a cohesive failure does not occur during peeling and the PSA does not leave a residue on a surface of the adherend. Also, components of the fluid analysis cartridge 100 may be bonded together by a method in which protrusions are inserted into indentations. Also, components of the fluid analysis cartridge 100 may be bonded together by a method in which protruded portions are inserted into indentations.

FIGS. 5 to 9 show side cross-sectional views of a fluid analysis cartridge according to another exemplary embodiment. Compared to FIG. 3, the fluid analysis cartridge 100 in FIG. 5 may further include a filter 140 that is spaced apart from the valve 130 and disposed in the fluid inlet hole 111a, and the filter 140 filters a specific material included in the fluid. The assistant plate 110 may include a fourth plate 110a contacting the valve 130, and a fifth plate 110b disposed on the fourth plate 110a and contacting the filter 140.

The filter 140 may be disposed on the valve 130 and the filter 140 may also be a membrane blocking the fluid inlet hole 111a. The filter 140 may include a polymer membrane such as polycarbonate (PC), polyether sulfone (PES), polyethylene (PE), polysulfone (PS), polyaryl sulfone (PASF) and the polymer membrane may have a porous structure for filtering the fluid.

For example, the fluid may be blood, and when blood passes through the filter 140 via the fluid inlet hole 111a, blood cells may be filtered and only plasma or blood serum may flow through the flow path 122. A porosity ratio of the polymer membrane may be about 1:1 to about 1:200 and an average diameter of the pores may be formed in a range of about 0.1 μm to about 10 μm. In this regard, the expression “porosity ratio” refers to a ratio of sizes of pores formed on the polymer membrane and, in more detail, a size of the smallest pore and a size of the largest pore may be expressed as a ratio. As the porosity ratio increases, a filtering speed increases.

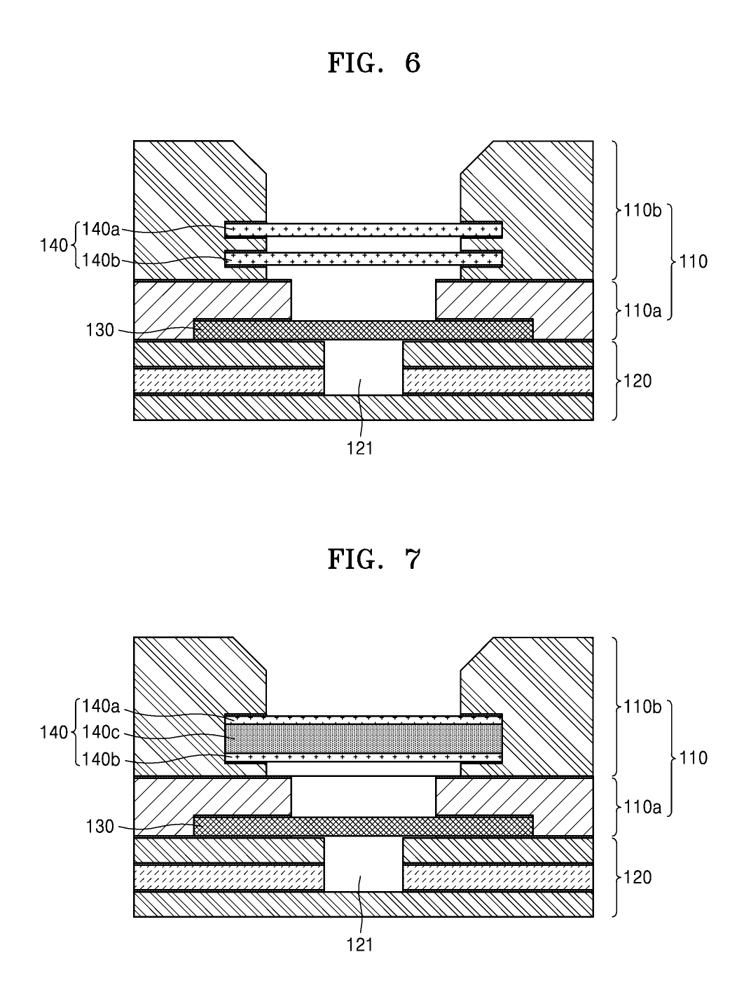

Also, the filter 140 may have a double-layered membrane structure as illustrated in FIG. 6. When the filter 140 is formed as a double-layered membrane, the fluid that passed through the first membrane 140a may be filtered again by the second membrane 140b. Also, when particles larger than the pore size of the membranes 140a, 140b flow toward the filter 140, the filter 140 may be prevented from being ripped or damaged. The filter 140 may include a triple-layered membrane, which further strengthens the filtering function with respect to the fluid and further improves stability of the filter 140. The filter 140 having two or three layers are only examples, and the filter 140 may include a membrane having four or more layers in consideration of the fluid flowing through the main plate 120 and the material subject to analysis in the main plate 120.

Alternatively, the filter 140 may be a porous membrane on which a coating layer of a functional material is formed on a surface thereof. The functional material may be a compound including at least one of a functional group including carbon and hydrogen such as alkane, alkene, alkyne, and arene; a functional group including a halogen atom such as a halogen compound; a functional group including oxygen such as alcohol and ether; a functional group including nitrogen such as amine and nitrile; a functional group including sulfur such as thiol and sulfide; a functional group including a carbonyl group such as carbonyl, aldehyde, ketone, carboxylic acid, ester, amide, carboxylic acid chloride, and carboxylic acid anhydride.

When a functional material having a specific function is coated on a surface of the porous membrane, a material that binds or adsorbs to the functional material while the fluid passes through the porous membrane may not pass through the porous membrane and becomes filtered. Accordingly, the specific material present in the fluid may be filtered.

The filter 140, as illustrated in FIG. 7, may have a structure in which a functional material 140c is used to fill a space between a double-layered membrane 140a and 140b. For example, when boronic acid or concanavalin A is filled between the double-layered membrane 140a and 140b, an amount of glycated hemoglobin of a patient may be measured efficiently.

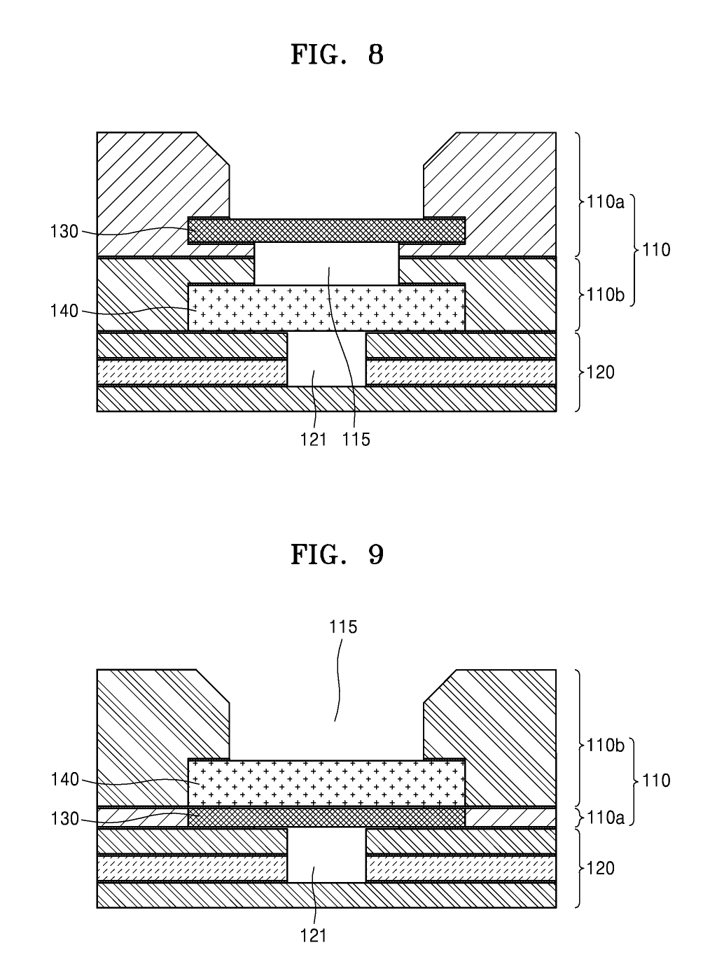

Also, as shown in FIG. 8, the filter 140 may be disposed below (see FIG. 8) the valve 130. The filter 140 may have a structure which is the same as at least one of the structures described above and thus, a detailed description thereof is omitted herein. Also, as illustrated in FIG. 9, the filter 140 may be disposed on the valve 130. Even though all materials in the fluid pass through the valve 130 according to pressure, the filter 140 is slightly different from the valve 130 in that only materials other than the specific materials pass through the filter 140. The valve 130 and the filter 140 have different functions; however, it is preferable to form a space which may become an assistant reaction chamber 115, between the filter 140 and the valve 130, to procure time for the fluid to pass through the filter 140. Also, another reagent may be injected into the assistant reaction chamber 115. However, the exemplary embodiments are not limited thereto. The filter 140 may be disposed on the valve 130.

The fluid which flows through the fluid inlet portion 111 of the assistant plate 110 in the fluid analysis cartridge 100 according to an exemplary embodiment may flow in a direction including a vertical direction into the assistant plate 110, and may flow into the main plate 120 via at least one of the valve 130 and the filter 140. The fluid which flows into the main plate 120 may flow in a horizontal direction through the flow path 122, which is provided in a horizontal direction, to flow into at least one of the reaction chambers 125, and may undergo various reactions in the reaction chamber 125. Optical or electrical changes of resultants obtained during or after the reaction of the fluid in the reaction chamber 125 described above may be measured for quantification.

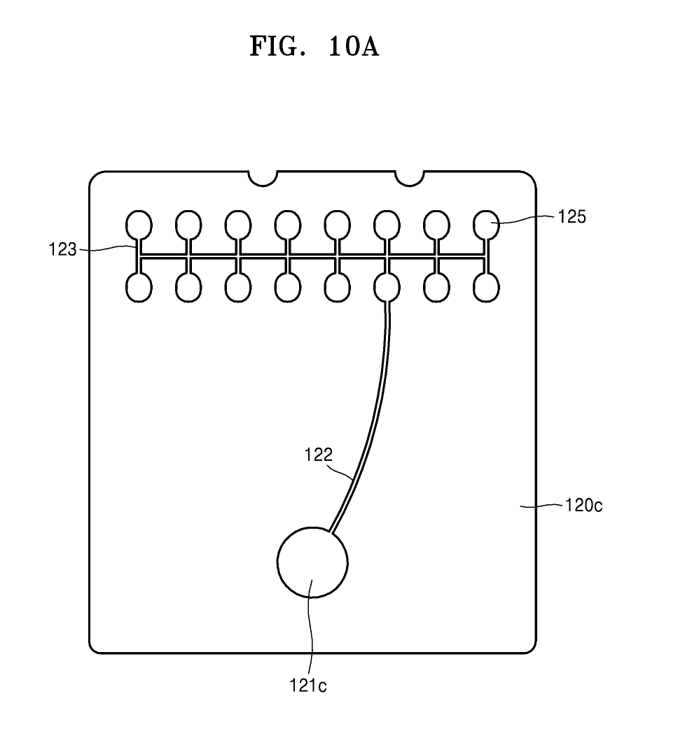

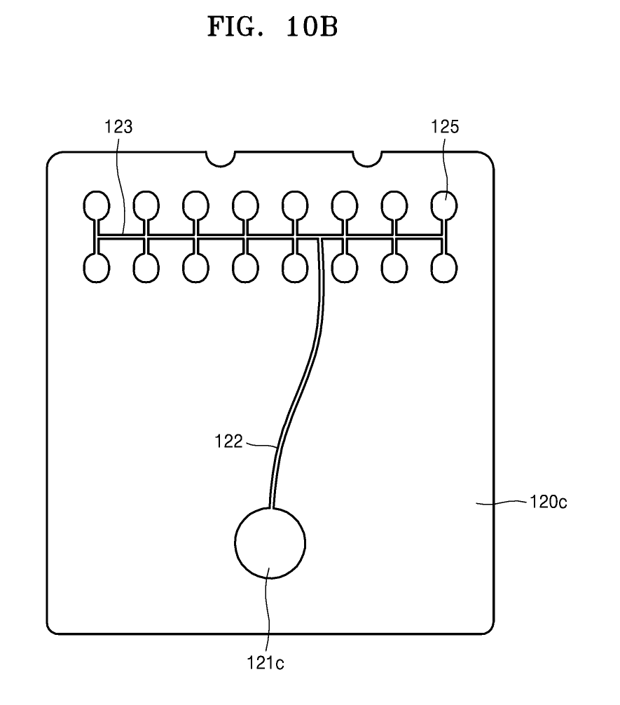

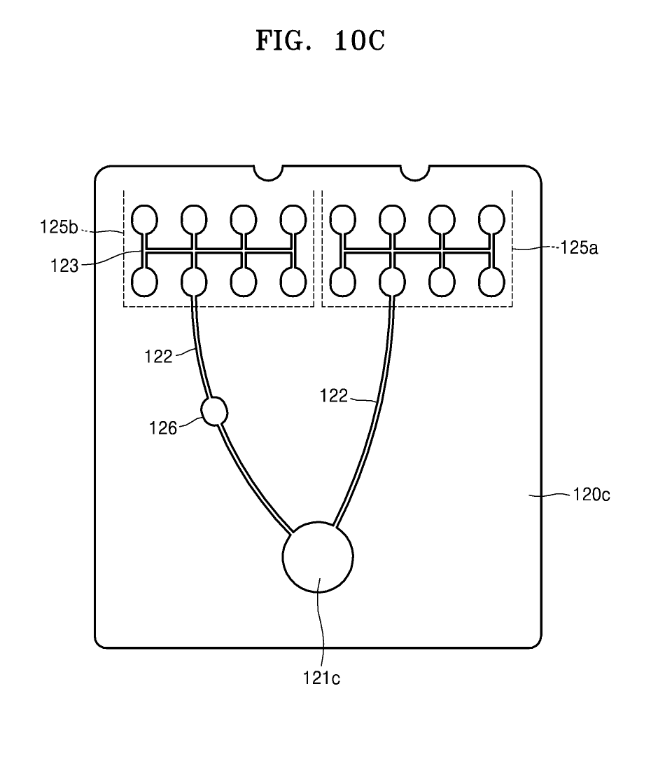

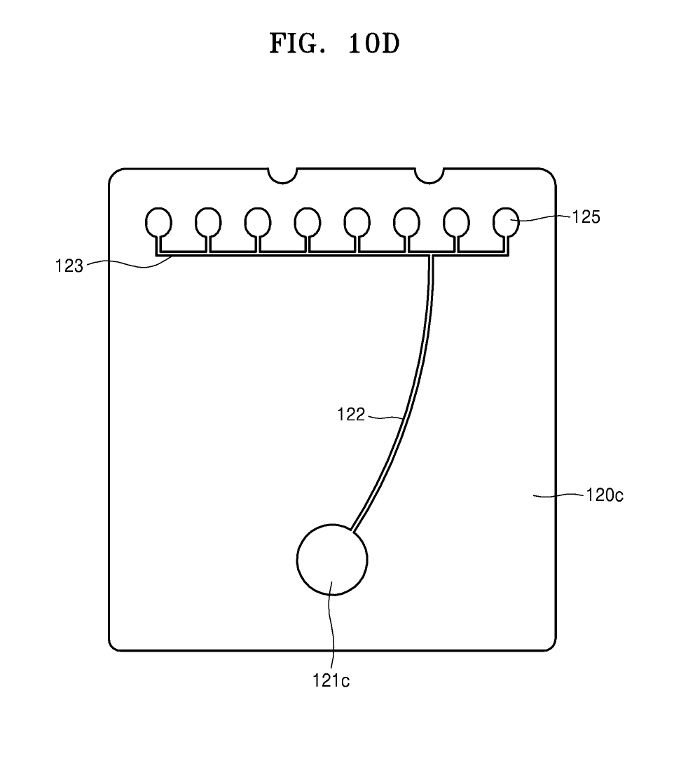

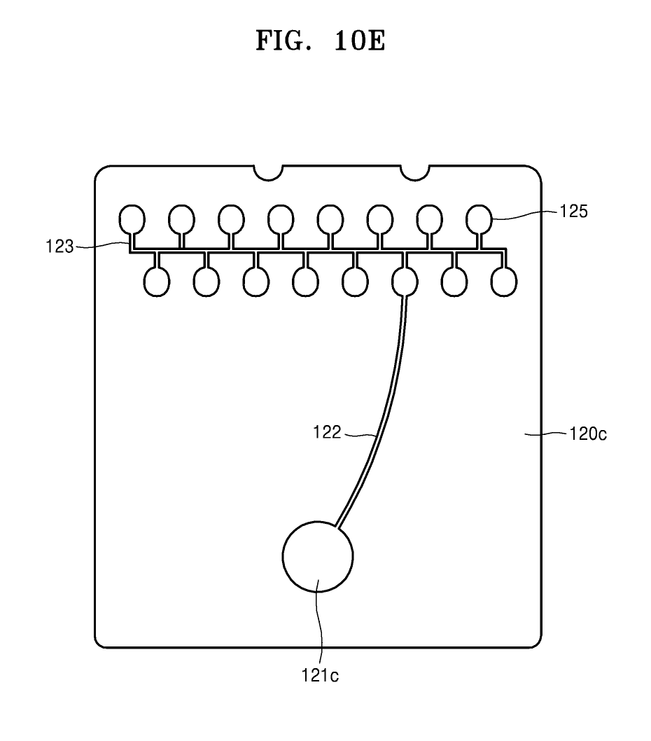

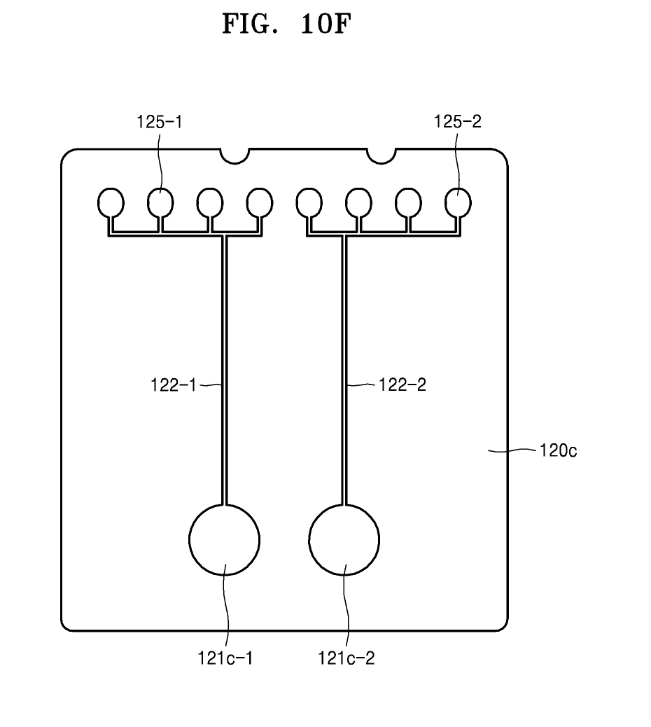

The flow path 122 and the reaction chamber 125 are materially formed by the third plate 120c, and a shape of the third plate 120c is described henceforth. FIGS. 10A to 10F are plan views of the third plate 122 in the main plate 120 of the fluid analysis cartridge 100 according to an exemplary embodiment.

Referring to FIG. 10A, an entrance 121c via which the fluid may flow is formed on the third plate 120c, and when the first plate 120a, the third plate 120c, and the second plate 120b are bonded together, the entrance 121a of the first plate 120a and the entrance 121c of the third plate 120c overlap to form an entrance 121 of the main plate 120.

In the third plate 120c, a reaction chamber 125 is formed on a side opposite to a side having the entrance 121c. For example, in the third plate 120c, a region corresponding to the reaction chamber 125 and having a shape such as a circle or a rectangle is removed to form the reaction chamber 125. As shown in FIG. 2, portions corresponding to the first plate 120a and the second plate 120b of the reaction chamber 125 are not perforated and thus, when a partial portion of the third plate 120c is removed, a reaction chamber 125 for storing a fluid and a reagent may be formed. For example, when a hole is formed on the third plate 120c, the hole may become the reaction chamber 125. Alternatively, a minute storage container may be disposed in the region of the third plate 120c from which the portion is removed to be used as a reaction chamber 125.

Also, as described above, when a region corresponding to the shape of the reaction chamber 125 in the first plate 120a and the second plate 120b is formed to be transparent, a reaction occurring in the reaction chamber 125 or a resultant thereof may be easily viewed from outside the reaction chamber 125.

In the reaction chamber 125, various reactions for analyzing a fluid may occur, and as an example of a case in which blood is used as the fluid, a reagent that reacts with specific components of blood (for example, plasma) and expresses or changes colors upon reaction is stored in the reaction chamber 125 beforehand. Colors expressed in different reaction chambers may thereby be optically detected for quantification thereof. Numerical values obtained therefrom may be used to identify the presence or the absence of the specific components in blood or a ratio of the specific components.

In the third plate 120c, a flow path 122 that enables the fluid which flows into the entrance 121c to flow into the reaction chamber 125 may be formed. Also, a region corresponding to the flow path 122 may be removed from the third plate 120c to form the flow path 122. The flow path 122 may be formed to have a width of about 1 μm to about 500 μm.

As illustrated in FIG. 10A, the flow path 122 may connect the entrance 121c and one of the plurality of reaction chambers 125. The fluid which flows into the entrance 121c may pass through flow path 122 due to capillary force, and flow into one of the plurality of reaction chambers 125. In addition, due to capillary force, the fluid may enter into each reaction chamber 125 through a branched flow path 123 that connects the plurality of reaction chambers 125, and subsequently react with the reagent in each reaction chamber 125.

In this regard, the reaction chamber 125 directly connected to the entrance 121c through the flow path 122 may be empty or may be filled with a reagent or a reaction solution for a pretreatment of the fluid.

Alternatively, as illustrated in FIG. 10B, the flow path 122 may not be directly connected to one of the plurality of reaction chambers 125 and may be directly connected to the branched flow path 123 instead. Accordingly, the flow path 122 may be connected to one of the plurality of reaction chambers 125 or the branched flow path 123 according to various design considerations, such as, for example, the type of the fluid or the type of examination performed in the reaction chamber 125.

In the drawings described thus far, only one flow path 122 is connected to the entrance 121c. However, as illustrated in FIG. 10C, two flow paths 122 may be connected to the entrance 121c. In this case, the plurality of reaction chambers 125 may be divided into two inspection regions 125a and 125b, and when a middle chamber 126 having a substance stored therein for use in pretreatment is formed on any one of the flow paths 122, the pretreatment may be performed only in the inspection region 125b connected to the flow path 122, while a fluid in which a primary reaction has already occurred may flow through the flow path 122 without the middle chamber 126. Alternatively, a middle chamber 126 may be formed on each of the two flow paths 122. In each middle chamber 126, different pretreatments may be performed or a primary reaction may occur due to different reagents or reaction solutions.

FIG. 10C illustrates a case in which two flow paths 122 are connected to the entrance 121c. However, exemplary embodiments are not limited thereto, and three or more flow paths 122 via which the fluid may flow into three or more inspection regions may be connected to one entrance 121c.

In the drawings described thus far, the plurality of reaction chambers 125 may be arranged opposite to each other to form two rows of reaction chambers 125, but as illustrated in FIG. 10D, it is possible to align the reaction chambers 125 to form a single row of reaction chambers 125. In this case, transparent regions of the first plate 120a and the second plate 120b are also disposed on regions corresponding to the reaction chambers 125.

Alternatively, as illustrated in FIG. 10E, the plurality of reaction chambers 125 may be arranged opposite to each other to form two rows of reaction chambers 125, in which upper and lower reaction chambers 125 are alternately arranged in a zigzag manner. When the upper and lower reaction chambers 125 are alternately arranged, the fluid flows with some time lag while moving from one reaction chamber 125 to another reaction chamber 125. In more detail, when the fluid passes through one of the plurality of reaction chambers 125 and then separates into other reaction chambers 125, a reagent or a reaction solution for the pretreatment of the fluid may be stored in a reaction chamber 125 through which the fluid passes first (e.g., the reaction chamber 125 connected to the flow path 122). However, the reaction chamber 125 connected to the flow path 122 may be left empty.

Also, as described above, the fluid analysis cartridge 100 may include two or more inlet holes, which enable the flow of the fluid thereinto. When the fluid flow inlet of the assistant plate 110 includes two or more inlet holes, the main plate may also include two or more entrances corresponding thereto. For example, when the fluid inlet portion 111 includes two fluid inlet holes 111a, then, as illustrated in FIG. 10F, the third plate 120c also includes two entrances 121c-1 and 121c-2. Also, although not illustrated in the drawings, a first plate also includes two corresponding entrances.

Fluids that flow through the two entrances 121c-1 and 121c-2 may be different types of fluids, and the different types of fluids may respectively pass through inflow paths 122-1 and 122-2 respectively connected to the entrances and flow into the plurality of separated reaction chambers 125-1 and 125-2.

According to a more detailed exemplary embodiment, in FIG. 10F, a plurality of reaction chambers 125-1 connected to a first entrance 121c-1 via a first inflow path 122-1 may store reagents for blood analysis and a plurality of reaction chambers 125-2 connected to a second entrance 121c-2 via a second inflow path 122-2 may include reagents for tissue fluid analysis, such that two types of fluids may be simultaneously analyzed in one fluid analysis cartridge 100.

Alternatively, the plurality of reaction chambers 125-1 connected to the first entrance 121c-1 and the plurality of reaction chambers 125-2 connected to the second entrance 121c-2 may include the same reagents as one another, and blood extracted from different patients or objects may respectively pass through the first entrance 121c-1 and the second entrance 121c-2 and flow into the plurality of separated reaction chambers 125-1 and 125-2.

FIG. 10F illustrates a case in which two entrances are formed on the third plate 120c, but as described above, three or more fluid inlet holes 111a may be formed and three or more corresponding entrances 121c may be formed on the third plate 120c. In this regard, for each of the three or more fluid inlet holes 111a, an entrance 121a formed on the first plate 120a corresponds to an entrance 121c of the third plate 120c and a fluid inlet hole 111a. Structures of the reaction chamber 125, the flow path 122, and the entrance may be configured to have various structures similar to the combination of the reaction chamber 125, the flow path, and the entrance described above with respect to FIG. 10F.

### EXAMPLE 1

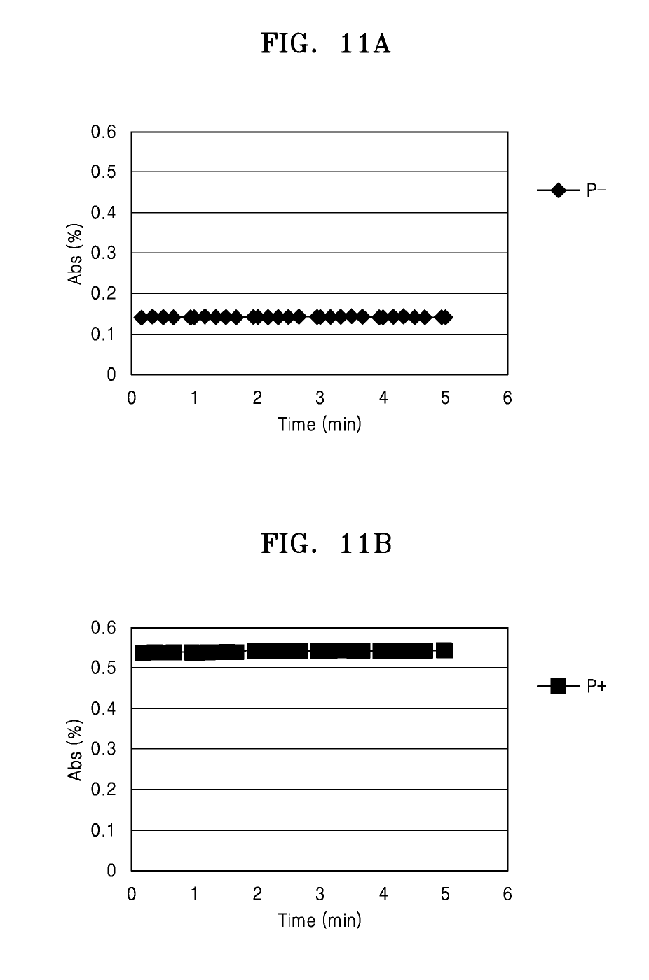

The valve 130 of the fluid analysis cartridge 100 in FIG. 1 was formed to have a shape as illustrated in FIG. 3 and polytetraflouroethylene was used for the valve 130. Also, a subject of analysis was hemoglobin and a sample was blood diluted 50 times in a hemolysis buffer (250 mM NH₄OAc, 40 mM MgCl₂, 0.5 w/w % Triton-X100, and 0.06 w/w % SDS). FIGS. 11A and 11B show absorbances in a reaction chamber according to application of pressure to the fluid analysis cartridge 100 of FIG. 1. After injecting the sample into the fluid inlet portion, the absorbance in the reaction chamber 125 was measured at an atmospheric pressure for 5 minutes without pressurizing the fluid inlet portion. The measured absorbance was, as shown in FIG. 11A, about 0.15. This result shows that the sample stayed in the fluid inlet portion and did not flow into the reaction chamber 125 during the 5 minute measurement period.

Meanwhile, the absorbance in the reaction chamber 125 was measured after injecting the sample into the fluid inlet portion and then pressurizing the fluid inlet portion. The absorbance was, as shown in FIG. 11B, increased to 0.5 or greater as soon as the fluid inlet portion was pressurized. This result shows that the sample passed through the valve and flowed into the reaction chamber 125.

### EXAMPLE 2

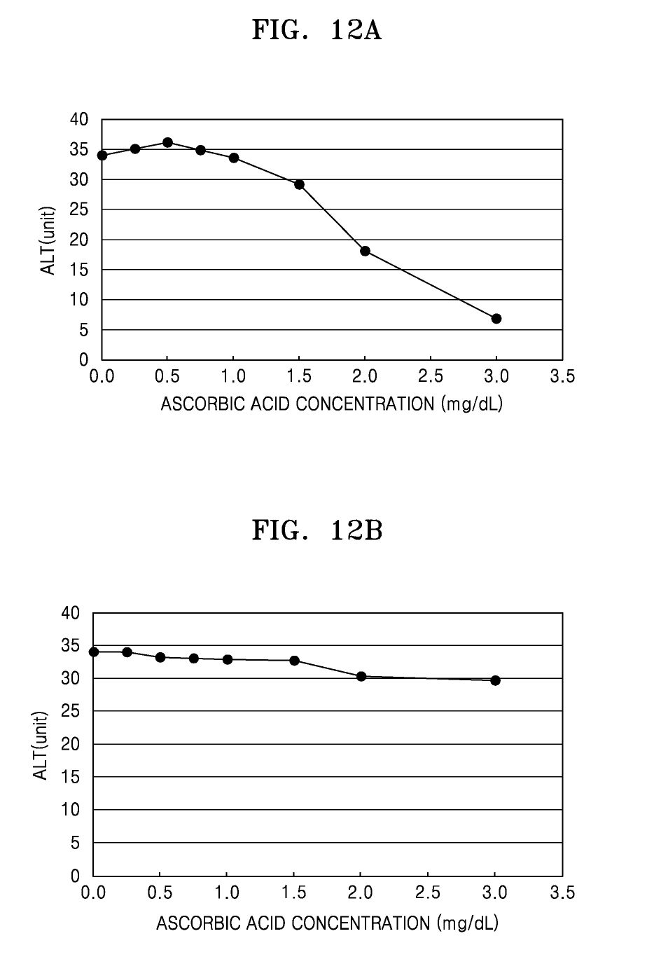

Next, a test was performed to determine whether the space formed by the valve and the assistant plate functions as the assistant reaction chamber 115. The fluid analysis cartridge 100 having a structure as illustrated in FIG. 3 was used. In the absence of dry coating of an ascorbic acid oxidase on a surface of the valve 130, 8 types of blood including ascorbic acid having a concentration in a range of about 0 mg/dL to about 3.0 mg/dL were used as samples. FIG. 12A is a graph showing a relationship between a concentration of ascorbic acid and alanine aminotransferase (ALT) when an oxidase is not present. In this regard, ascorbic acid is an inhibitor in an ALT measurement and thus, the greater the ascorbic acid content in blood, the lower the ALT value. Also, an ascorbic acid oxidase is an inhibitor antagonist that oxidizes and inactivates ascorbic acid. As shown in FIG. 12A, the ALT value decreased as the concentration of the ascorbic acid increased in the reaction chamber. This result shows that as the concentration of ascorbic acid increases in blood, the apparent ALT value decreases, which causes difficulties in precisely measuring the ALT value.

On the other hand, a dry coating of the ascorbic acid oxidase at a concentration of about 61×10⁻³ units was applied to ABC and a relationship between the concentration of ascorbic acid added to blood and the ATL value was measured. The results are shown in FIG. 12B. As shown in FIG. 12B, the ALT value did not decrease even though the concentration of the ascorbic acid increased. This result shows that the ascorbic acid reacted with the ascorbic acid oxidase in the assistant chamber and was thereby inactivated. Accordingly, the assistant reaction chamber including the valve and the assistant plate contributes to a more precise detection of a reagent.

Thus, the fluid analysis cartridge according to the exemplary embodiments may provide improved convenience to a user and enable an analysis of a plurality of fluids by using only one cartridge. Also, the fluid analysis cartridge according to the exemplary embodiments may use a pressure difference to control the flow of the fluid and thus, the fluid analysis cartridge may easily control the flow of the fluid. Further, the fluid analysis cartridge according to the exemplary embodiments has a simple structure. Also, according to another aspect of the fluid analysis cartridge according to the exemplary embodiments, a polymer membrane, through which a fluid passes, may be coated with or filled with a functional material, such that separation of a specific material may be enabled.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the exemplary embodiments as defined by the following claims.

What is claimed is:

1. A fluid analysis cartridge comprising:
an assistant plate comprising an inlet hole configured to receive a fluid;
a main plate configured to receive the fluid via the assistant plate and further configured to store a reagent configured to react with the fluid; and
a valve provided in the inlet hole and configured to control a flow of the fluid into the main plate according to pressure in the inlet hole.

2. The fluid analysis cartridge of claim 1, wherein the valve is configured to block the fluid from flowing into the main plate when the pressure is less than or equal to a first pressure.

3. The fluid analysis cartridge of claim 2, wherein the first pressure is an atmospheric pressure.

4. The fluid analysis cartridge of claim 1, wherein when the pressure is greater than or equal to a second pressure, the fluid passes through the valve and flows into the main plate.

5. The fluid analysis cartridge of claim 4, wherein the second pressure is higher than an atmospheric pressure.

6. The fluid analysis cartridge of claim 1, wherein the valve comprises a membrane configured to block the inlet hole.

7. The fluid analysis cartridge of claim 1, wherein the valve comprises a hydrophobic material.

8. The fluid analysis cartridge of claim 1, wherein the valve comprises a gas-permeable material.

9. The fluid analysis cartridge of claim 1, wherein the valve comprises at least one of polytetrafluoroethylene (PTFE), polyethylene (PE), polypropylene (PP), polysulfone (PSF), polyacrylonitrile (PAN), and cellulose acetate (CA).

10. The fluid analysis cartridge of claim 1, wherein the main plate comprises:
a first plate;
a second plate spaced apart from the first plate; and
a third plate provided between the first and second plates and comprising a reaction chamber configured to store the reagent and a fluid path configured to guide the fluid through the main plate towards the reaction chamber.

11. The fluid analysis cartridge of claim 10, wherein the third plate is formed of a gas-permeable material.

12. The fluid analysis cartridge of claim 10, wherein the first and second plates are formed of at least one film selected from polyethylene films formed of a very low density polyethylene (VLDPE), linear low density polyethylene (LLDPE), low density polyethylene (LDPE), medium density polyethylene (MDPE), and high density polyethylene (HDPE); a polypropylene (PP) film; a poly (vinyl chloride) (PVC) film; a polyvinyl alcohol (PVA) film; a polystyrene (PS) film; and a polyethylene terephthalate (PET) film.

13. The fluid analysis cartridge of claim 1, wherein the assistant plate is formed of at least one selected from among polymethylmethacrylate (PMMA), polydimethylsiloxane (PDMS), polycarbonate (PC), linear low density polyethylene (LLDPE), low density polyethylene (LDPE), medium density polyethylene (MDPE), high density polyethylene (HDPE), polyvinyl alcohol, very low density polyethylene (VLDPE), polypropylene (PP), acrylonitrile butadiene styrene (ABS), cycloolefin copolymer (COC), glass, mica, silica, and a semiconductor wafer.

14. The fluid analysis cartridge of claim 1, further comprising a space configured to store the fluid, the space being formed by the valve and a surface of the assistant plate.

15. The fluid analysis cartridge of claim 1, wherein the valve is provided between the assistant plate and the main plate.

16. The fluid analysis cartridge of claim 1, wherein the assistant plate further comprises a filter provided in the inlet hole, wherein the filter is spaced apart from the valve and is configured to filter a specific material included in the fluid.

17. The fluid analysis cartridge of claim 1, wherein the assistant plate further comprises a filter provided in the inlet hole, wherein the filter is provided on the valve and is configured to filter a specific material included in the fluid.

18. The fluid analysis cartridge of claim 16, wherein the filter comprises a membrane configured to block the inlet hole.

19. The fluid analysis cartridge of claim 16, wherein the assistant plate comprises:
a fourth plate contacting the valve; and
a fifth plate disposed on the fourth plate and contacting the filter.

20. The fluid analysis cartridge of claim 1, wherein the assistant plate is configured to guide the fluid in a first direction, and the main plate is configured to guide the fluid in a second direction perpendicular to the first direction.

21. The fluid analysis cartridge of claim 1, wherein the reagent comprises a substance configured to generate an optically or electrically measurable result of a reaction between the fluid and the reagent.

22. A portable cartridge, comprising:
an assistant plate comprising a grip portion shaped to correspond to a grip of a user and a fluid receiving portion configured to receive a fluid, the grip portion and the fluid receiving portion being unitary;
a main plate provided adjacent to the assistant plate and configured to store a substance configured to react with the fluid; and
a valve provided in the fluid receiving portion and configured to control a flow of the fluid into the main plate according to pressure applied to the fluid receiving portion.

23. The portable cartridge of claim 22, wherein the assistant plate is formed of plastic.

24. The portable cartridge of claim 22, wherein the valve is embedded in a side of the assistant plate.
